(19) United States
(12) Patent Application Publication
(10) Pub. No.: US 2009/0065723 A1
(43) Pub. Date: Mar. 12, 2009

(54) Plastic bobbin with creep prevention feature

(76) Inventor: Miguel I. Avila, Juarez (MX)

Correspondence Address: DELPHI TECHNOLOGIES, INC., M/C 480-410-202, PO BOX 5052, TROY, MI, 48007, US

(21) Appl. No.: 11/900,413

(22) Filed: Sep. 11, 2007

(51) Int. Cl. F16K 31/06; H01F 7/08

(52) U.S. Cl. 251/129.15; 335/261

(57) ABSTRACT

A solenoid actuated valve includes a plastic nylon bobbin which has a relatively rigid portion which supports the electrical actuation coil and a separate, relatively resilient portion, which is integrally formed with the rigid portion of the bobbin for the mounting thereof. An armature is positioned for reciprocating displacement within a central passageway of the bobbin in response to selective energization of the coil. A spool valve is operatively connected for movement with the armature. A frame assembly supports the solenoid valve and continuously compressively loads the resilient portion of the bobbin within a non-plastic range of deformation.

### TECHNICAL FIELD

The present disclosure relates generally to solenoids, and particularly to solenoid valves.

### BACKGROUND OF THE INVENTION

Solenoids are used in a myriad of applications in the automotive industry. For example, solenoids may be used for high power switches with a lower power control signal. Solenoids are also used in automated or remote valves, such as a canister vent solenoid associated with evaporative emission control systems. Such solenoid valves may be used to control the flow of a variety of fluids or gasses. For example, in the context of a canister vent solenoid, the solenoid valve may be used to control the flow of fuel vapors into a charcoal canister. Solenoid valves may be similarly used to control the flow of liquids and vapors for other vehicle systems.

### SUMMARY OF THE INVENTION

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1, is a broken, perspective cross-sectional view of the actuator portion of an automotive oil control valve assembly embodying the present invention;

FIG. 2, is a rotated, front plan view of an electromagnetic coil, secondary magnetic flux plates and supporting bobbin from the actuator of FIG. 1;

FIG. 3, is a side plan view of the bobbin from the actuator of FIG. 1 on a substantially enlarged scale with a mesh superimposed thereon for FEA analysis of the hinge-like feature at the base of the bobbin;

FIG. 4, is a rotated, front plan view of the bobbin similar to that of FIG. 2, but with the electromagnetic coil and secondary magnetic flux plates removed, to illustrate structural detail of the bobbin itself;

FIG. 5, is a broken, side plan view of the bobbin of FIG. 4 on an enlarged scale illustrating the (relatively rigid) portion of the bobbin for supporting the electromagnetic coil and (relatively resilient) base portion for flexing in response to varying axial loads;

FIG. 6, is a broken, side plan view of an bobbin similar to that of FIG. 5 embodying an alternative embodiment of the invention;

FIG. 7, is a broken, side plan view of a bobbin similar to that of FIG. 5 embodying a second alternative embodiment of the invention;

FIGS. 8-16, each depict a common side plan view of a model bobbin similar to that of FIG. 2 illustrating a Normal stress map calculated for an axially applied pressure varying incrementally from 0 MPa (FIG. 8) to 200 MPA (FIG. 16);

FIGS. 8A-16A, correspond with FIGS. 8-16, respectively, but with the Normal stress maps illustrated in color;

FIG. 17, is a broken, cross-sectional view of the base portion of the bobbin of FIGS. 1-5 in an axially unloaded or relaxed condition;

FIG. 18, is a broken, cross-sectional view of the base portion of the bobbin if FIGS. 1-5 in an axially loaded condition; and

FIG. 19, is a cross-sectional view of the bobbin of FIG. 4.

Although the drawings represent embodiments of the present invention, the drawings are not necessarily to scale and certain features may be exaggerated in order to illustrate and explain the present invention. The exemplification set forth herein illustrates an embodiment of the invention, in one form, and such exemplifications are not to be construed as limiting the scope of the invention in any manner.

### DESCRIPTION OF THE PREFERRED EMBODIMENT

Although suitable for many automotive and non-automotive applications, the present invention is particularly well adapted for use in an automotive oil control valve, and will be described in that context.

In previous automotive oil control valve designs, it was noted that the bobbin can become loose after durability tests and engine tests. It is surmised that the bobbins can become loose due to the difference in thermal expansion coefficients between steel and plastic, that creates a creeping effect or deformation in the plastic. This can result in objectionable rattling, fluid leaks of malfunction of the device. Benchmarking demonstrated that existing competitive designs have similar design issues which were addressed by varying solutions such as press fits, separate spring washers and crimping steel-to-steel surfaces. Although partially effective solutions, these approaches prove to be expensive and can introduce new failure modes. An additional solution is the use of a crush rib which can only retard or lessen (but not fully resolve) the effect.

The present invention provides a cheap (negligible additional cost) and permanent solution.

The present invention proposes a hinge-like feature at the base of the bobbin that will damp the effect of the force exerted during the crimping operation (of the frame) during assembly. Over time, as the plastic yields beneath the steel frame, the hinge will spring-back (because it will not reach its yield strength) and retain rigidity of the assembly.

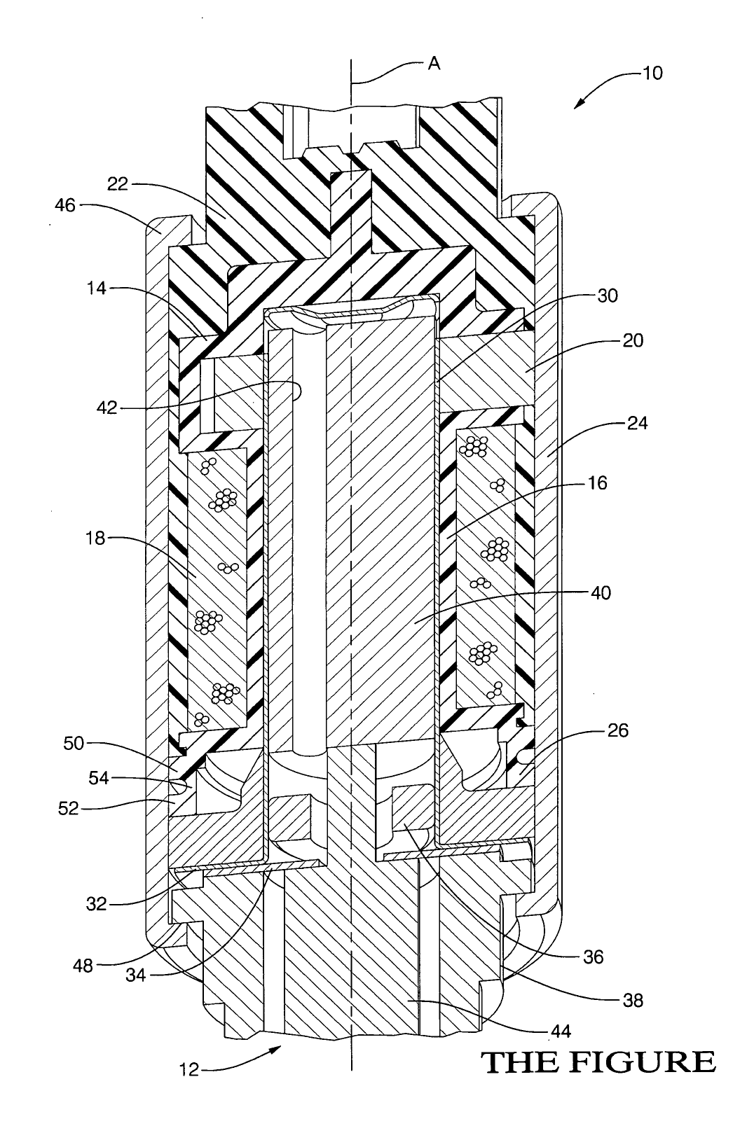

Referring to FIG. 1, a solenoid actuator assembly 10 for use with an automotive oil control valve 12 (shown partially) is illustrated. The actuator assembly 10 includes a subassembly including a bobbin 14 formed in one piece of injection molded plastic such as nylon. The bobbin has a main or base portion 16 which carries an electromagnetic coil 18 on the outer surface thereof. One end of the bobbin 14 is closed to define an electrical connector terminal interface as well as mounting features for a secondary magnetic flux plate 20 (steel). The bobbin 14 is overmolded with non-conductive plastic-like material 22.

The subassembly, including the bobbin 14 and the overmolding material 22 is disposed within a generally cylindrical steel can or magnetic frame 24, the inner diameter surface of which is in close proximity with the secondary plate 20. The open end of the bobbin 14 defines a skirt-shaped portion 26 which extends axially from the base portion 16. The base portion 16 and skirt portion 26 are integrally formed of nylon or other suitable material. The base portion 16 of the bobbin 14 is dimensioned and configured to be relatively rigid while the skirt portion 26 is dimensioned to be relatively resilient, particularly in the axial direction (A-A).

A primary magnetic flux plate 28 (steel) is press fit within the frame 24 and includes an annular opening concentric with the central opening of the bobbin 14 for receiving a generally cylindrical/tubular cup guide 30. Cup guide 30 has a flange 32 extending radially from the lower portion thereof which is clamped in position by a steel washer 34. An inner primary magnetic flux plate 36 (steel) is disposed within the cup guide 30.

A steel housing 38 extends axially from the frame 24 to become the oil control valve 12. An armature/plunger 40 is slidably disposed within the guide cup 30 and defines an axially extending damping passageway 42 therethrough. A steel spool valve 44 extends through housing 38 into valve 12.

The axial ends of the frame 24 are crimped radially inwardly to abut abut a radial step 46 formed in overmolding material 22 and a radial step 48 formed in housing 38 to apply an axial compressive load to the bobbin 14, inter alia.

The skirt portion 26 of the bobbin is formed as upper and lower axially spaced rings 50 and 52, respectively, and an axially intermediate thin-walled section or web 54 integrally formed therewith. As best viewed in FIGS. 17 and 18, the upper portion of the web 54 transitions into upper ring 50 to define a downwardly (axially) facing abutment surface 56. Likewise, the lower portion of the web 54 transitions into the lower ring 52 to define an upwardly (axially) facing abutment surface 58. Abutment surfaces 56 and 28 are thus axially spaced when the bobbin is in the relaxed position as depicted in FIG. 17. The point of transition of the main portion 16 of the bobbin 14 into the skirt portion 26 also defines opposed, axially spaced abutment surfaces 60 and 62, respectively, intersaced by a web 63.

When the frame 24 is crimped as part of the final assembly of the actuator assembly 10, axially compressive loading is imposed upon the bobbin as depicted by arrows 64 and 66 in FIG. 18. Depending upon the axial force applied and other factors, such as ambient temperature, opposed abutment surfaces 56 and 58 as well as opposed abutment surfaces 60 and 62 will (axially) approach one another as their respective webs 54 and 63 are compressed and deformed. Under maximum design loading (as depicted in FIG. 18), the abutment pairs 56/58 and 60/62 can approach or even contact one another. Further axial force levels beyond design limits will result in potentially destructive loading/deformation of the entire bobbin.

The rings 50 and 52 as well as the web 54 are configured to ensure that the localized material forming the skirt portion 26 never exceed its characteristic yield point and, as a result, will maintain the bobbin 14 under compressive loading during thermal transition induced shrinkage and long term load induced creeping of the bobbin material.

It is to be understood that the invention has been described with reference to specific embodiments and variations to provide the features and advantages previously described and that the embodiments are susceptible of modification as will be apparent to those skilled in the art.

Furthermore, it is contemplated that many alternative, common inexpensive materials can be employed to construct the basis constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. For example, . . . It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

The specification of the below listed U.S. Patents and applications are incorporated herein by reference:

U.S. Pat. No. 6,065,495 to Fong et al.

U.S. 2005/0012062 A1 to Hayashi

U.S. 2006/0054851 A1 to Young et al.

U.S. 2005/0199846 A1 to Kim et al.

U.S. Pat. No. 6,119,725 to Shinobu et al.

U.S. Pat. No. 5,588,414 to Hrytzak et al.

U.S. Pat. No. 5,992,822 to Nakao et al.

U.S. Pat. No. 6,371,164 to Sakata et al.

U.S. 2005/0081810 A1 to Isobe et al.

U.S. Pat. No. 5,146,196 to Frank

U.S. Pat. No. 5,119,055 to Kidd et al.

U.S. Pat. No. 5,148,136 to Kid

U.S. Pat. No. 5,038,123 to Brandon

1. A solenoid valve comprising;
a bobbin including a relatively rigid portion configured to support a coil and a relatively resilient portion integrally formed with said rigid portion;
an armature disposed for reciprocating displacement within said bobbin in response to selective electrical energization of said coil;
valve means operatively connected to said armature; and
a frame assembly operative to continuously compressively load the resilient portion of said bobbin.

2. The solenoid valve of claim 1, wherein said bobbin is formed of homogeneous material.

3. The solenoid valve of claim 2, wherein said homogeneous material is injection molded plastic.

4. The solenoid valve of claim 2, wherein said homogeneous material is nylon.

5. A solenoid comprising:
a bobbin including a relatively rigid portion configured to support a coil and a relatively resilient portion integrally formed with said rigid portion;
an armature disposed for reciprocating displacement within said bobbin in response to selective electrical energization of said coil; and
a frame assembly operative to compressively load the resilient portion of the bobbin.

6. The solenoid of claim 5, wherein said frame assembly compressively loads the resilient portion of the bobbin within a non-plastic region of deformation.

7. The solenoid of claim 5, wherein the resilient portion of the bobbin comprises at least one thin-wall section.

8. The solenoid of claim 7, wherein said thin-wall section is circumferentially continuous.

9. The solenoid of claim 5, wherein said bobbin comprises one or more abutment surfaces operative to limit axial distension of said bobbin in response to application induced loading.

10. The solenoid of claim 5, wherein the resilient portion of the bobbin defines opposed, axially spaced abutment surfaces straddling a thin-wall section.
